(19) United States
(12) Patent Application Publication
(10) Pub. No.: US 2012/0200091 A1
(43) Pub. Date: Aug. 9, 2012

(54) PORTABLE POWER GENERATION UNIT

(76) Inventor: Sunyo J. Pearson, Harrisburg, NC (US)

(21) Appl. No.: 13/365,803

(22) Filed: Feb. 3, 2012

Related U.S. Application Data
(60) Provisional application No. 61/439,789, filed on Feb. 4, 2011.

(51) Int. Cl. H02K 7/18

(52) U.S. Cl. 290/1 R

(57) ABSTRACT

The system described herein allows for a combination of water passing over a Pelton wheel and super-heated steam directed to a steam turbine to control a common shaft engaging an electrical generator. The system is contained within a common housing and is portable for delivery to the most remote locations.

### CROSS REFERENCE TO PRIOR APPLICATIONS

This application claims priority to and incorporates entirely by reference U.S. Provisional Patent Application Ser. No. 61/439,789 filed on Feb. 4, 2011.

### FIELD OF THE INVENTION

The invention relates to power generation for areas that are under-served or not served at all by standard utilities. The invention encompasses a portable power generator utilizing water pumped across a Pelton Wheel in addition to power from super heated steam directed to a steam turbine for converting kinetic energy into electrical power.

### BACKGROUND OF THE INVENTION

The prior art fails to show a portable power generation unit that enables power generation in areas where the only resource is water or other hydraulic fluids. None of the systems known to date allows a user to provide potential energy via a compressed spring housed in a cylinder and connected to a piston to convert that potential energy to other forms of useful energy for power generation purposes.

A U.S. patent application by Romanelli et al. (U.S. 2006/0059912) discloses a two cylinder set-up for power generation, with pressure differentials in each, and controls the flow of water between the two. Granted, this document also uses heat exchange to accomplish its overall power generation process, but it is significant in its disclosure of two cylinders using vacuum pressure to alternately pump hydraulic fluid in a power plant. Instead of pistons, Romanelli uses expanding gases to set up different pressures to drive the power generation equipment.

U.S. Pat. No. 3,028,727 (Anston, 1962) shows a multi-cylinder set-up with pistons pumping and retracting alternately to control a water feed to a Pelton wheel. This document, therefore, shows the cylinders (11, 35) alternately providing hydraulic power to a Pelton wheel and recirculating the water. Anston provides potential power via weights (19).

In regard to using weights for potential energy, United Kingdom Patent No. 11,974 (Rhodes, 1915) shows that at least one publication notes that you can replace weights with springs to provide potential power. See Rhodes page 5 lines 20-30. A need continues in the art of power generation for a system that generates power from more efficient sources of potential energy. One such source, described herein, is found in the potential energy of springs.

### BRIEF DESCRIPTION OF THE DRAWINGS

FIG. 1 is a schematic view of a power generation unit according to this detailed description.

FIG. 2 is a detailed view of a triggering mechanism used in accordance with the power generation unit described herein.

FIG. 3 is a top view of the power generation unit described herein.

FIG. 4 is a side view of the power generation unit described herein.

FIG. 5 is an elevation view of a cross section of the steam clutch described herein.

FIG. 6 is an elevation view of a cross section of the over-speed brake described herein.

FIG. 7 is a side perspective view of the power generation unit described herein.

FIG. 8 is a rear perspective view of the power generation unit described herein.

FIG. 9 is a front perspective view of the power generation unit described herein.

### DETAILED DESCRIPTION

The portable power generation unit shown in the Figures is characterized in part by its use of spring driven pistons (15, 25) that seal corresponding cylinders (10, 20). The pistons are dimensioned to traverse the cylinders along the major axis of each cylinder. The unit is portable in part because the initial potential energy necessary to begin operating the unit is provided in the form of properly specified springs (29, 30) connected to the pistons. In a compressed state, the springs have the potential energy to drive the pistons and maintain energy production. The springs are also efficiently toggled between compressed and extended states to provide a source of potential energy as needed in opposing parts of the system. In one embodiment, the system utilizes a pair of cylinders (10, 20) with respective springs (29, 30) and includes an initial configuration in which one spring (30) is compressed with a respective piston (25) in an elevated initial position at one end of a respective cylinder (20). In this embodiment, the other cylinder (20) includes a piston (15) in an opposite position at a bottom portion of the cylinder (20) and a respective spring (29) in an extended state. These opposite positions for respective springs and pistons set the stage for the compressed spring to start a process of both springs toggling between extended and compressed states, thereby driving respective pistons in opposite directions within the cylinders.

The power generation unit includes components that work with the pistons in an overall system for generating electrical power. A tank (19) serves as a reservoir for a fluid that will be used in a hydraulic system of pushing the fluid in a compressed state. In one embodiment, the fluid is water, and the tank is a water tank (19). The tank maintains a level of fluid, most likely water, that is typically between two-thirds and three-fourths the total capacity of the tank (19). The tank (19) is adapted for replenishing the fluid as necessary without disassembling the entire machine.

The tank (19) is connected to inlet ports (16, 21) and outlet ports (11, 12), all of which extend between portions of the tank (19) and respective cylinders (10, 20) to allow the tank and the cylinders to be in fluid communication with each other. The system is adapted to start its power generation capabilities as soon as the tank is filled with water (or any appropriate fluid) to the proper level. The power generation occurs as soon as the potential energy of the initially compressed spring is released. The releasing mechanism of the compressed spring is described in more detail in conjunction with FIG. 2.

FIG. 2 is a detailed figure showing how one of the springs (29, 30) can be held in a compressed state (maximizing potential energy). FIG. 2 is illustrated in relation to cylinder (20) and piston (25) but is equally applicable to the other cylinder. Either or both cylinders may include the mechanism shown in FIG. 2. For purposes herein, and without limiting the invention, the mechanism of FIG. 2 is referred to as the “triggering mechanism” for convenience. The mechanism may be implemented as a fixture that fits within an opening defined by the solid body of a piston (15, 25). As such, each piston may be outfitted with an appropriate embodiment of a triggering mechanism adapted to release a compressed spring associated with that piston (15, 25). The triggering mechanism of FIG. 2 is best described in relation to the sequence of events that produce the triggering effect of releasing a compressed spring (30) used within the power generation unit.

When a piston (15, 25) is in its uppermost or farthest position within a respective cylinder (i.e., as close as possible to one end of the cylinder), the spring attached to the piston is sandwiched between the piston (30) and the cylinder (20). This position ordinarily compresses the spring to its appropriate state for the desired potential energy. The position of the spring is held intact by a removable spring pin (17). The spring pin (17) may be manually or mechanically removed by lifting a pin cover (31) and lifting the pin (32) out of engagement with the spring (30). The spring (30) then pushes the piston (25) across the length of the cylinder (20).

To aid in the efficiency of the pin (32) releasing the spring (30), the fixture within the piston includes a latch mechanism that holds the piston in place when the spring (30) is in compression and releases the piston (25) as necessary to generate power. The latch mechanism includes a first brace (37A) which is held in a level position about a fixed pivot ring (48). The first brace is held in place by the removable pin (32) pushing downwardly with a force that equals the amount of force necessary to compress an associated fixed attachment spring (38A) connected to the wall of the cylinder (20). The first brace (37A) pivots about the middle ring (48). When the pin (32) is engaged with the spring (30), one end of the first brace (37A) pushes up against the attachment spring (38A) as the other end of the first brace (37A) is subject to the downward force of the pin (32). When the pin (32) is removed, a first end of the first brace (37A) (proximate the pin (32)) moves upwardly, and the attachment spring (37A) proximate a second end of the first brace is allowed to expand. The attachment spring (38A) pushes the second end of the first brace (37A) in one direction while the first end goes in an opposite direction about pivot ring (48). The pivoting motion of the first brace (37A) releases a pair of catches (49A, 49B) and allows a second brace (37B) to release. A second attachment spring (38B) pushes the second brace in the direction of the expanding second attachment spring (38B). The second brace (37B) pushes against a third brace (37C). The third brace (37C) is connected to the cylinder wall by a hinged connector (not shown). When the second brace (37B) pushes against the third brace (37C), the third brace (37C) fits into a compartment designed within a wall of the cylinder (20). The third brace (37C) is the piece that holds the piston in a fixed position to compress the spring (30). When the third brace (37C) is moved by the second brace (37B) into the cylinder wall, the piston (30) is allowed to move across the major axis of the cylinder to traverse the cylinder (20). On the other hand, when the piston is positioned to compress and hold the spring (30) against the cylinder wall with the retaining pin (32) in place, the third brace (37C) assists in locking the piston in its holding position. Overall, the triggering mechanism is one way to prepare the unit for power generation by moving the piston (25) to a position that compresses the spring (30) and provides potential for the system. By pushing the piston in a position that compresses the spring (30), the third brace (37C) is allowed to hold the piston (25) in this loaded position, and the insertion of the removable pin (32) ensures that the latching mechanism has sufficient potential to release the piston when the pin is removed.

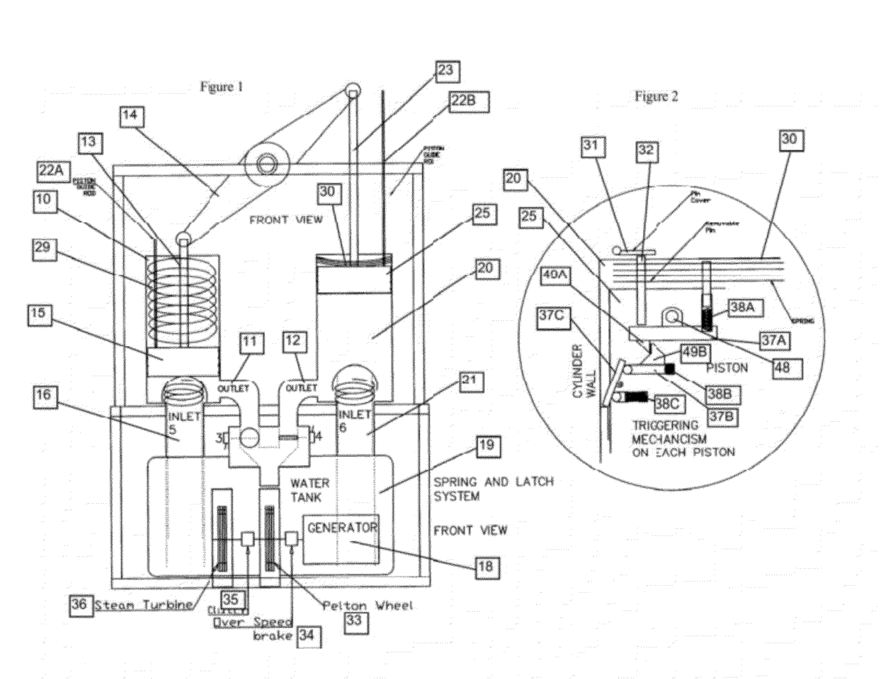

Returning to FIG. 1, the system may be characterized in part (without limiting the invention) as a pump actuated by a pair of springs (29, 30) having equal and opposite potential energy at any given time. The springs are compressed and held in place by a respective piston that may include the above described latching fixture. Upon actuating the springs (29, 30) by removing the above-described pin (32), the system will begin to pump fluid (hereinafter water) through the system. As noted above, each cylinder (10, 20) has a respective piston (15, 25) connected to respective springs (29, 30) that move the springs across the major axis of the respective cylinder. The pistons are connected by piston rods (13, 23) connected to opposite ends of a pivoting cross bar (14). The cross bar (14) pivots about a midpoint connector so that as one piston moves in one direction, the other piston is pulled in an opposite direction. Accordingly, when the removable pin (32) is removed from a first spring held in compression, that spring pushes the respective piston across the cylinder while the cross bar (14) pulls the other piston in an opposite direction across the other cylinder. All of the cylinders are sealed by the pistons and connected to inlets and outlets that are, in turn, connected to the water tank (19). The motions of the pistons up and down, alternately create vacuum forces that pull water into the cylinder through inlets (16, 21) or push water out of the cylinders through outlets (11, 12). The portable power generation unit described herein, therefore, encompasses the use of alternating pulling and pushing of water to and from a respective cylinder on opposite sides of the water tank.

The outlet of each cylinder, in use alternately as described above, pushed compressed water across a Pelton wheel (33) that is known in the art of power generation for turning the shaft (27) of the electrical generator (18). The electrical generator (18) is one of many known in the art as providing electrical power to a load (not shown). The Pelton wheel is consistently turned by water emanating from one outlet (11, 12) or the other as the pistons move in opposite paths (i.e., up and down) across the cylinders. Accordingly, the electrical generator can be used for power in locations where standard utility services are not available, but water is available for use in the above-described machine. The overall unit may include a removable shell that serves as a housing.

The electrical power generated as noted above can be used in some embodiments of the invention to power more sophisticated control systems. Accordingly, the invention encompasses improved constructions that have automated and electronically controlled valves, switching, and standardized modern control technology. The spring-based potential energy is used to start power generation across the Pelton wheel, and then energy production in excess of the load requirements can be used to power more extensive machinery.

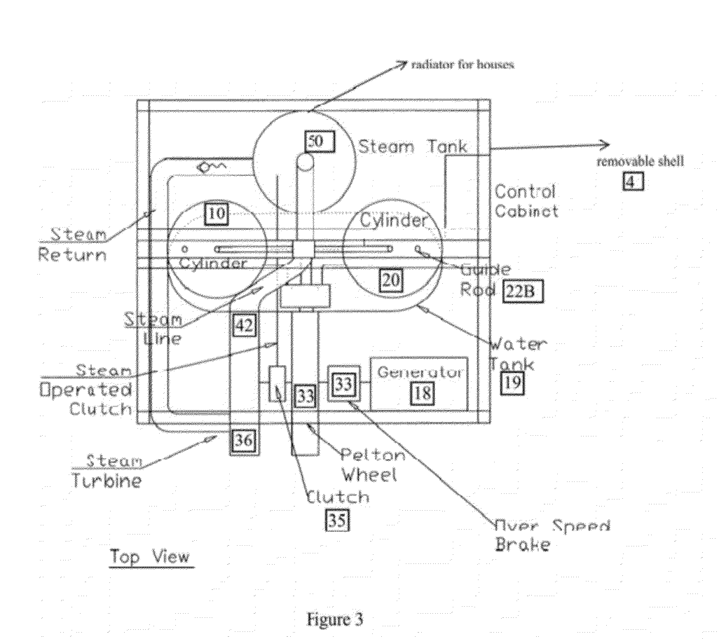

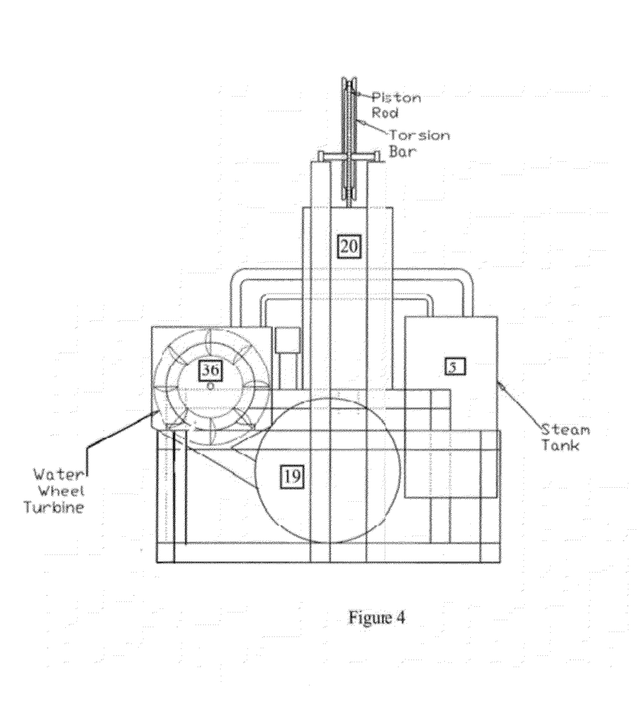

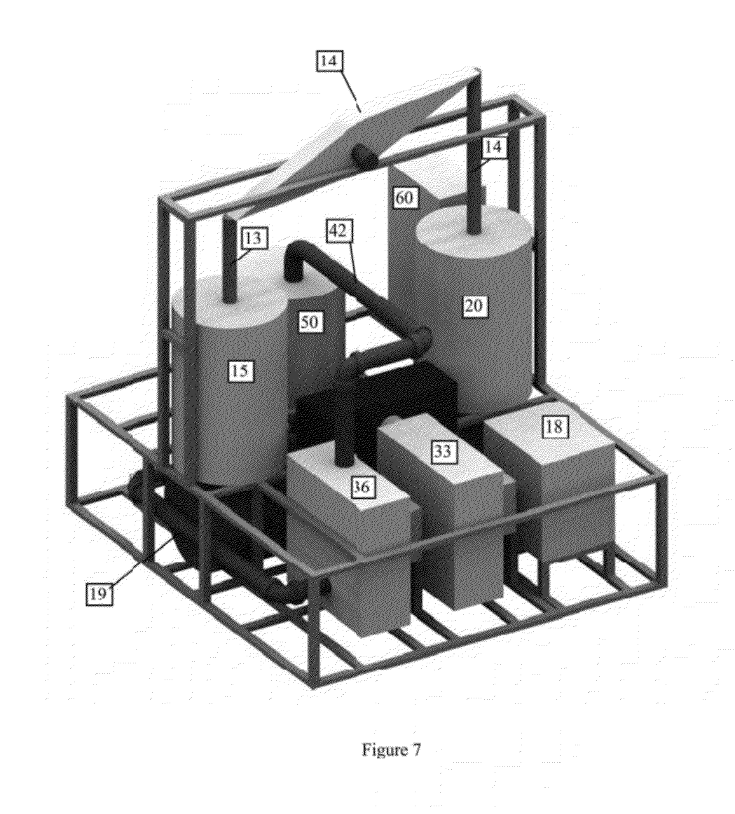

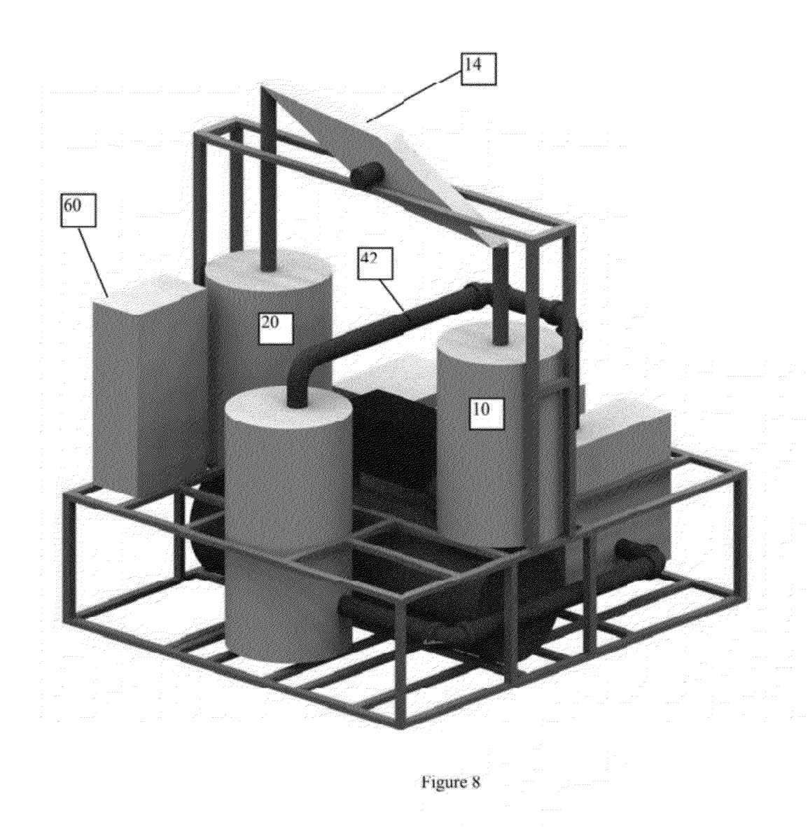

One way to use excess power generated by the portable unit is to incorporate all means necessary for producing electricity from steam. In an embodiment shown in FIGS. 3-8, the above noted system is enhanced with a heating tank (50) for producing steam. In fact, the system may be utilized to an extent that superheated steam is transferred from the heating tank (50) to a steam turbine (36) that works in unison with the Pelton wheel (33). The steam turbine (36) and the Pelton wheel (33) combine to turn the common shaft (27) of the generator (18). Of course, this generates even more power.

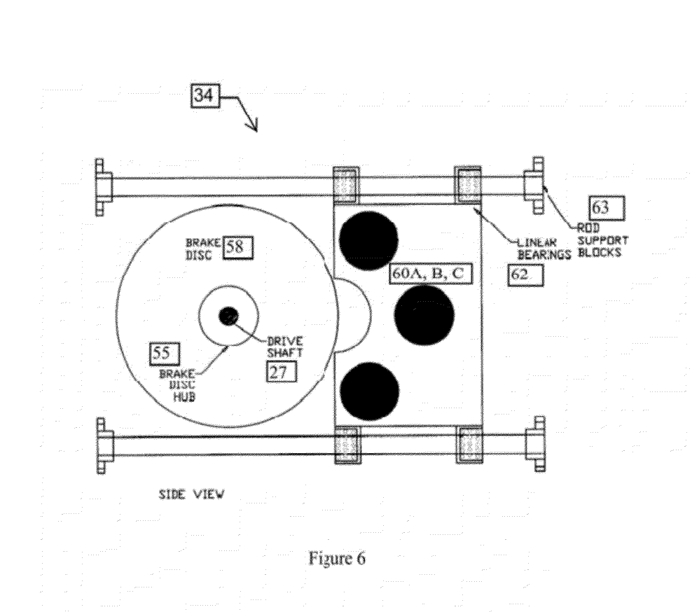

The system encompasses controls to ensure that the combination of the steam turbine (36) and the Pelton wheel (33) do not exceed the capabilities of the generator. In particular, the system incorporates an over-speed brake (34) onto the common shaft (27) of the electrical generator (18). The over-speed brake is shown in close up view at FIG. 6. The over-speed brake ensures that the common shaft is controlled to stay within the limits of the specifications of the generator at hand. The over-speed brake may be controlled electronically by a digital control system that is powered from electricity generated in situ. As shown in FIG. 6, the over-speed brake encompasses a disk brake hub (55) surrounding the common shaft of the generator (18). The disk brake hub (55) is an attachment point for a disk brake (58) about the common shaft (27). The control system moves a housing across rails incorporated into the overall braking mechanism (34) such that magnets (60A, 60B, 60C) move across the disk brake (58) and slow down the drive shaft (27). This is a first control on the amount of power driving the common shaft (27) turning the generator (18).

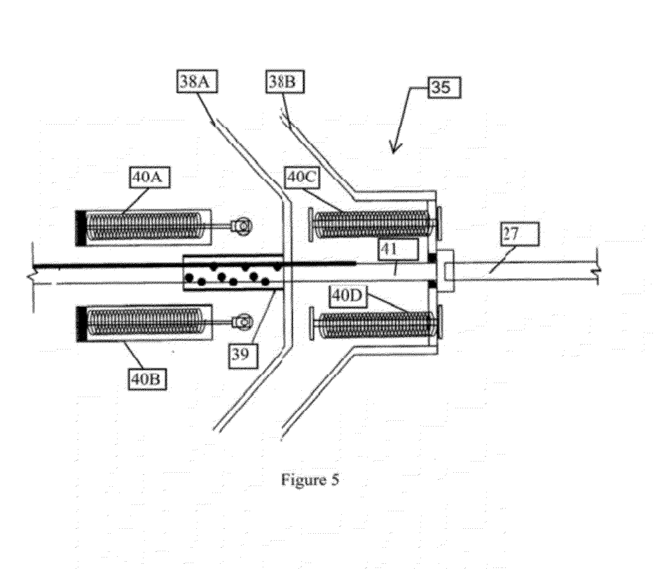

As noted above, the system includes embodiments that combine a steam turbine (36) and a Pelton wheel (33) to maximize power generation for specified conditions. The system includes a second control feature to ensure that the steam turbine (36) is used only as necessary and only when sufficient steam has been generated in the heating tank (50). FIG. 5 shows this second control feature in the form of a steam turbine clutch (35). As shown in the Figure, the clutch (35) is disengaged by separating two clutch plates (38A, 38B) across linear bearings (39). The clutch plates remain disengaged whenever the above noted control system determines that the only power generation should originate at the Pelton wheel. Similarly, the clutch plates (38A, 38B) may disengage when there is insufficient steam generated in the heating tank (50). Springs (40A, 40B, 40C, 40D) allow for the plates to engage and disengage as the springs are allowed to compress and expand. Again, one goal of the clutch is to ensure proper load on the common shaft (27).

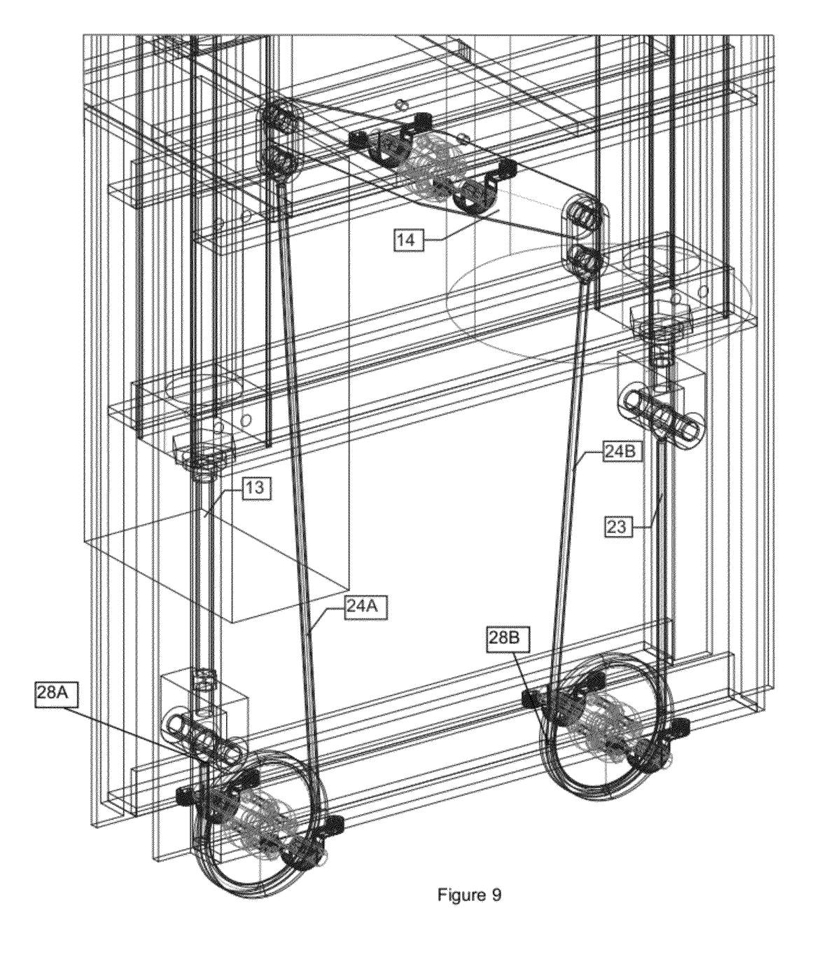

As noted above, each cylinder (10, 20) has a respective piston (15, 25) connected to respective springs (29, 30) that move the springs across the major axis of the respective cylinder. The pistons are connected by piston rods (13, 23) connected to opposite ends of a pivoting cross bar (14). The cross bar (14) pivots about a midpoint connector so that as one piston moves in one direction, the other piston is pulled in an opposite direction. Accordingly, when the removable pin (32) is removed from a first spring held in compression, that spring pushes the respective piston across the cylinder while the cross bar (14) pulls the other piston in an opposite direction across the other cylinder. In an embodiment shown at FIG. 9, the cross bar (14) may be moved to a position closer to the midsection of each cylinder (10, 20). This embodiment allows for cables (24A, 24B) to actuate the piston rods (13, 23) by connecting the cables across pulleys and connecting the cables (24A, 24B) to the piston rods (13, 23). Numerous kinds of attachment points (28A, 28B) are available to connect the cables to the piston rods (13, 23). In one non-limiting embodiment of the system, piston rod (13) moves downwardly toward a pulley as a first cylinder evacuates and allows a first cable (24A) and one end of the cross bar (14) to move upwardly. The opposite end of the cross bar (14) moves downwardly and pushes the piston rod (23) upwardly to create the above-described vacuum in an associated cylinder. Otherwise, the system proceeds as described above.

The system described herein allows for a combination of water passing over a Pelton wheel and super-heated steam directed to a steam turbine to control a common shaft engaging an electrical generator. The system is contained within a common housing and is portable for delivery to the most remote locations.

The invention is further illustrated by the claims that follow.

1. A system for generating electric power by forcing water from a cylinder across a Pelton wheel comprising:
a fluid reservoir holding a fluid;
a pair of first and second hollow cylinders connected to said fluid reservoir for transporting water into and out of said reservoir;
respective first and second pistons sealing each cylinder and positioned within said cylinders such that said pistons are moveable to traverse said cylinders;
a first spring attached to said first piston;
a second spring attached to said second piston;
a pivoting cross bar having respective opposite ends connected to respective piston rods that move said first and second pistons upwardly and downwardly;
wherein upward direction of one of said pistons forms a vacuum within a respective cylinder, thereby moving fluid from said reservoir into said respective cylinder such that the fluid has a potential to drive the Pelton wheel.

2. A system according to claim 1, further comprising a removable latch pin holding said first or second spring in a state of compression, wherein, upon removing said latch pin, said first or second spring pushes said respective piston into one of said cylinders, and said pivoting cross bar pulls the other piston upwardly within the other cylinder, thereby forcing fluid from said fluid reservoir into said other cylinder.

3. A system according to claim 1, further comprising a respective outlet and a respective inlet connected between each cylinder and said reservoir, wherein fluid from said reservoir enters a respective cylinder through said inlets and exits said cylinders through said outlets.

4. A system according to claim 3, further comprising respective inlet valves opened and closed by a respective piston.

5. A system according to claim 4, wherein said inlet valves are closed by a valve spring pressed by a piston.

6. A system according to claim 4, wherein the vacuum formed by one of said pistons close said outlet valve and opens said inlet valve.

7. A system according to claim 3, wherein the Pelton wheel is in fluid communication with said outlet valves, said Pelton wheel turning upon the force of fluid exiting said cylinders.

8. A system according to claim 7, wherein said Pelton wheel is connected to an electrical generator.

9. A system according to claim 8, wherein said generator is connected to a load.

10. A system according to claim 9, wherein said load comprises a heating tank holding water.

11. A system according to claim 10, wherein said heating tank provides steam to an associated radiator.

12. A system according to claim 10, wherein said heating tank provides steam to maintain an operating temperature for the system.

13. A control system for maintaining the operation of an electrical generator, the control system comprising:
a fluid reservoir holding a fluid;
a pair of first and second hollow cylinders connected to said fluid reservoir for transporting water into and out of said reservoir;
respective first and second pistons sealing each cylinder and positioned within said cylinders such that said pistons are moveable to traverse said cylinders;
a first spring attached to said first piston;
a second spring attached to said second piston;
a pivoting cross bar having respective opposite ends connected to respective piston rods that move either of said first and second pistons upwardly or downwardly while moving the other of said first and second pistons in an opposite direction, wherein upward direction of one of said pistons forms a vacuum within a respective cylinder, thereby moving water from said reservoir into said respective cylinder;
respective pairs of inlets and outlets connected between said fluid reservoir and said cylinders;
a Pelton wheel in fluid communication with said outlets, wherein fluid pushed by said pistons drives said Pelton wheel to drive the generator attached to a load, wherein electrical power generated by said Pelton wheel is connected to a return circuit to power an electrical control system.

14. A control system according to claim 13, further comprising a heating tank holding water and generating steam.

15. A control system according to claim 14, wherein said return circuit provides power from said generator to a heater connected to said heating tank.

16. A control system according to claim 14, further comprising a steam line connecting said heating tank to a steam turbine.

17. A control system according to claim 16, further comprising a heating coil surrounding said steam line to heat steam in said steam line and form superheated steam.

18. A control system according to claim 16, wherein said steam turbine and said Pelton wheel drive a common shaft on said generator.

19. A control system according to claim 18, wherein said steam turbine engages and disengages said common shaft depending upon the pressure in said steam turbine.

20. A control system according to claim 19, further comprising a steam operated clutch for engaging and disengaging said steam turbine from said common shaft.

21. A control system according to claim 20, wherein said steam operated clutch comprises pairs of springs actuated by steam pressure from said steam turbine.

22. A control system according to claim 21, wherein said steam operated clutch further comprises a linear bearing surrounding said common shaft.

23. A control system according to claim 18, further comprising an over-speed brake selectively engaging said common shaft and protecting said generator.

24. A control system according to claim 23, wherein said overspeed brake is a magnetically controlled brake.

25. A control system according to claim 24, wherein said overspeed brake selectively engages said common shaft to reduce generator power in response to said electrical control system.

26. A control system according to claim 13, wherein the fluid in said fluid reservoir is water.

27. A system for generating electric power by forcing water from a cylinder across a Pelton wheel, comprising:
a fluid reservoir holding a fluid;
a pair of first and second hollow cylinders connected to said fluid reservoir for transporting water into and out of said reservoir;
respective first and second pistons sealing each cylinder and positioned within said cylinders such that said pistons are moveable to traverse said cylinders;
a first spring attached to said first piston;
a second spring attached to said second piston;
a pivoting cross bar having respective opposite ends connected to respective piston rods that move said first and second pistons upwardly and downwardly;
wherein upward direction of one of said pistons forms a vacuum within a respective cylinder, thereby moving fluid from said reservoir into said respective cylinder such that the fluid has a potential to drive the Pelton wheel;
a removable latch pin holding said first or second spring in a state of compression, wherein, upon removing said latch pin, said first or second spring pushes said respective piston into one of said cylinders, and said pivoting cross bar pulls the other piston upwardly within the other cylinder, thereby forcing fluid from said fluid reservoir into said other cylinder, wherein said latch pin is attached to a mechanical fixture connected to a respective piston within a void defined by the piston.

28. A system according to claim 27, wherein said mechanical fixture comprises a latch holding a respective piston at the top of a respective cylinder, wherein said cylinder holds a respective spring in a state of compression.

29. A system according to claim 28, wherein said mechanical fixture comprises a triggering mechanism controlled by trigger springs actuated upon removal of said latch pin.

30. A system according to claim 29, wherein said triggering mechanism pushes said latch into said respective cylinder, allowing said piston to traverse said respective cylinder in response to extension of said respective spring.

31. A system according to claim 27, further comprising a removable housing surrounding the system.
